(19) United States
(12) Patent Application Publication
(10) Pub. No.: US 2022/0389987 A1
(43) Pub. Date: Dec. 8, 2022

(54) DRIVETRAIN FOR A HYBRID OR ELECTRIC VEHICLE FITTED WITH AN DYNAMIC ABSORBER IN TORSION

(71) Applicant: VALEO EMBRAYAGES, Amiens (FR)

(72) Inventor: Eric RUMEAU, Cergy Pontoise (FR)

(73) Assignee: VALEO EMBRAYAGES, Amiens (FR)

(21) Appl. No.: 17/770,533

(22) PCT Filed: Oct. 20, 2020
(86) PCT No.: PCT/EP2020/079525

§ 371 Date: Apr. 20, 2022

(30) Foreign Application Priority Data
Oct. 21, 2019 (FR) 19 11762

(51) Int. Cl. F16F 15/14

(52) U.S. Cl. CPC F16F 15/1414; F16F 2236/08; F16F 2232/02; F16F 2222/08

(57) ABSTRACT

A drivetrain for motor vehicle including an electric motor and a reduction mechanism designed to transmit the driving torque to the wheels of the motor vehicle. The electric motor includes a rotor equipped with a rotor shaft, the rotor shaft being rotationally coupled to a primary shaft of the reduction mechanism. The drivetrain further includes a dynamic absorber in torsion, the dynamic absorber in torsion having a support element, an inertial mass which is mounted with the ability to rotate about an axis X with respect to the support element and elastic members which oppose the relative rotation of the inertial mass with respect to the support element about said axis X.

### TECHNICAL FIELD

The invention relates to the field of drivetrains for motor vehicles and notably for electric or hybrid vehicles, namely vehicles comprising at least one electric motor able to propel the vehicle.

### TECHNOLOGICAL BACKGROUND

Drivetrains comprising an electric motor able to propel the vehicle and a reduction mechanism, such as a gearbox, interposed in the path along which torque is transmitted between the shaft of the electric motor and the wheels of the vehicle are known from the prior art.

The applicant has found that electric motors do not generate a constant torque and exhibit acyclic behaviors notably brought about by deficiencies in the homogeneity of the magnetization of the magnets of the electric motor. These acyclic behaviors generate vibrations that can be transmitted to the entire drivetrain and to the wheels of the vehicle and can thus cause jolts, noises and noise annoyance, which are particularly undesirable. These acyclic behaviors are notably liable to generate vibrations that are particularly critical when their frequency corresponds to a resonant frequency of the drivetrain.

### SUMMARY

One idea underpinning the invention is to propose a drivetrain able to address the above-mentioned disadvantages, namely able to effectively filter out the vibrations liable to be generated by the electric motor.

In order to do this, the invention proposes a drivetrain for motor vehicle comprising an electric motor and a reduction mechanism designed to transmit the driving torque to the wheels of the motor vehicle; the electric motor comprising a rotor equipped with a rotor shaft, said rotor shaft being rotationally coupled to a primary shaft of the reduction mechanism, the drivetrain further comprising a dynamic absorber in torsion, said dynamic absorber in torsion comprising a support element, an inertial mass which is mounted with the ability to rotate about an axis X with respect to the support element and elastic members which oppose the relative rotation of the inertial mass with respect to the support element about said axis X.

Thus, by virtue of the dynamic absorber in torsion, vibrations in the drivetrain, particularly vibrations around a resonant frequency of said drivetrain, are limited.

According to other embodiments, the drivetrain may have one or more of the features described below.

According to one embodiment, the resonant frequency of the dynamic absorber in torsion is comprised between 1 and 20 Hz, and preferably between 4 and 10 Hz.

According to one embodiment, the inertial mass has a moment of inertia comprised between 0.001 and 0.010 kg.m², and more specifically between 0.005 and 0.006 kg.m².

According to one embodiment, the elastic members are configured to provide an angular stiffness comprised between 0.01 and 0.70 Nm/°.

According to one embodiment, the coupling device is a clutch device. According to one embodiment, the clutch device comprises a first clutch and a second clutch.

According to one embodiment, the reduction mechanism is a gearbox.

According to one embodiment, the gearbox comprises a first and a second primary shaft and the clutch device comprises a first and a second clutch, these respectively being intended to couple the rotor shaft to the first and to the second primary shaft.

According to one embodiment, the support element is positioned in such a way as to be rotationally driven when torque is being transmitted from the rotor shaft to the wheels of the vehicle, and is advantageously rotationally driven at the same speed as the rotor shaft.

According to one embodiment, the support element is rotationally fixed to the rotor shaft.

According to one embodiment, the rotor shaft is rotationally coupled to the primary shaft of the reduction mechanism by means of a coupling device.

According to one embodiment, the support element of the dynamic absorber in torsion is mounted on the coupling device. According to one embodiment, when the coupling device is a clutch device, the support element of the dynamic absorber in torsion is mounted on the mechanism or on a clutch disk of the clutch device.

According to one embodiment, the support element of the dynamic absorber in torsion is mounted on the primary shaft.

According to one embodiment, the support element is mounted on the rotor shaft.

According to embodiment, the dynamic absorber in torsion comprises a hysteresis device. According to one advantageous embodiment, the hysteresis device is configured to apply a friction torque which increases as the angular travel of the inertial mass with respect to the support element increases.

According to one embodiment, the invention proposes a motor vehicle equipped with an aforementioned drivetrain.

### BRIEF DESCRIPTION OF THE FIGURES

The invention will be better understood, and other aims, details, features and advantages thereof will become clearer, from the following description of a plurality of particular embodiments of the invention, provided solely by way of nonlimiting illustration, with reference to the appended drawings.

FIG. 1 is a schematic depiction of a drivetrain according to a first embodiment.

FIG. 2 is a schematic depiction of a drivetrain according to a second embodiment.

FIG. 3 is a schematic depiction of a drivetrain according to a third embodiment.

FIG. 4 is a schematic depiction of a drivetrain according to a fourth embodiment.

FIG. 5 is a characteristic curve for a dynamic absorber in torsion according to one embodiment.

FIG. 6 is a characteristic curve for a dynamic absorber in torsion according to another embodiment.

### DESCRIPTION OF THE EMBODIMENTS

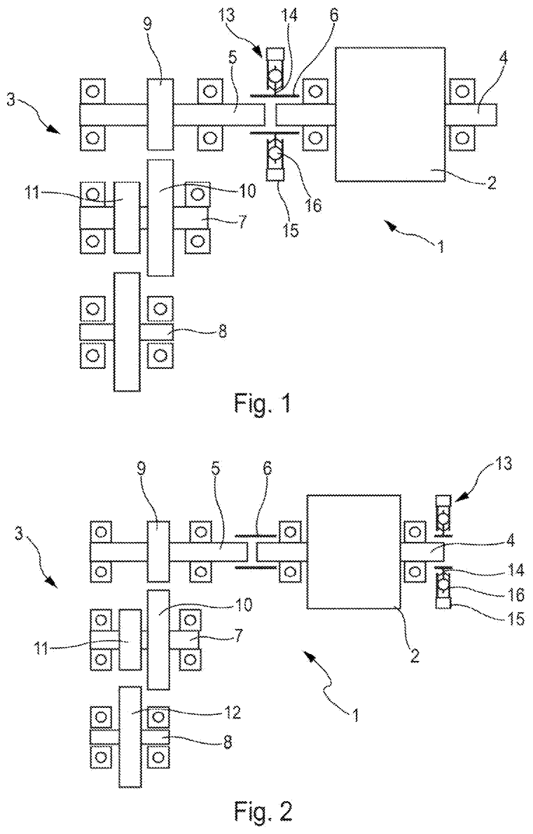

A drivetrain 1 of an electric vehicle according to a first embodiment is described hereinbelow with reference to FIG. 1. The drivetrain 1 comprises, in succession, along the path along which the torque is transmitted, an electric motor 2, a reduction mechanism 3 and a differential, not depicted, which is able to drive two laterally opposite wheels of the motor vehicle. The reduction mechanism 3 is able to achieve the desired levels of speed and torque at the vehicle wheels.

The electric motor 2 is, for example, a synchronous permanent magnet electric motor. The electric motor 2 comprises a stator, and a rotor equipped with a rotor shaft 4.

The reduction mechanism 3 comprises at least a primary shaft 5 which is rotationally coupled to the rotor shaft 4 by a coupling device 6. The coupling device 6 may notably be a permanent-coupling device or a clutch device. In the embodiment depicted, the coupling device 6 is a splined sleeve which collaborates, on the one hand, with splines, not illustrated, formed on the rotor shaft 4 and, on the other hand, with splines, not illustrated, formed on the primary shaft 5.

The reduction mechanism 3 further comprises a secondary shaft 7 and a tertiary shaft 8. The tertiary shaft 8 is able to be connected to the differential, which is itself connected to the wheels of the vehicle. The primary shaft 5, secondary shaft 7 and tertiary shaft 8 are positioned parallel to one another. The primary shaft 5 is equipped with a gearwheel 9 which meshes with a first gearwheel 10 rotating as one with the secondary shaft 7. The secondary shaft 7 further comprises a second gearwheel 11 which meshes with a gearwheel 11 rotating as one with the tertiary shaft 8. The numbers of teeth on the gearwheels 9, 10, 11, 12 are such that the reduction mechanism 3 is able to reduce the rotational speed from the primary shaft 5 towards the tertiary shaft 8, thereby making it possible to increase the torque.

According to a variant embodiment which has not been depicted, the reduction mechanism 3 is a gearbox having a plurality of reduction ratios. In that case, the drivetrain 1 comprises a clutch device configured to couple or uncouple the rotor shaft 4 with respect to the primary shaft 5 of the gearbox. Thus, such a clutch device allows the transmission of torque to be interrupted during a change of gear ratio.

According to one particular variant, the gearbox comprises a first primary shaft and a second primary shaft, which is hollow and surrounds the first primary shaft. Each of the first and second primary shafts comprises a gearwheel meshing with a gearwheel of the secondary shaft. In that case, the clutch device comprises a first and a second clutch which are respectively able to couple the rotor shaft 4 to the first and to the second primary shaft. In order to change gear ratio, one of the first and second clutches is moved from its engaged position to its disengaged position while the other is moved from its disengaged position to its engaged position so that the driving torque is transferred progressively from one of the first and second clutches to the other. Such a clutch device therefore makes it possible to change the gear ratio without a break in torque, which is to say while maintaining the transmission of a driving torque to the wheels of the vehicle.

The drivetrain 1 also comprises a dynamic absorber in torsion 13. Such an dynamic absorber in torsion 13 comprises a spring-mass system acting in parallel with the drivetrain 1 of the motor vehicle.

The dynamic absorber in torsion 13 comprises a support element 14, an inertial mass 15, for example of annular shape, which is mounted with the ability to rotate about the axis X with respect to the support element 14, and elastic members 16 such as springs. The elastic members 16 are positioned between the support element 14 and the inertial mass 15 and oppose relative rotation of the inertial mass 15 with respect to the support element 14 about the axis X. By way of example, structures of such dynamic absorbers in torsion 13 are described in documents FR3051029, FR3027985, FR2865516, FR2824374, WO11060752 and DE10201223751.

Such an dynamic absorber in torsion 13 is able to selectively filter out vibrations over a determined frequency range. Hence, the moment of inertia of the inertial mass 15 and the stiffness of the collection of elastic members 16 are tailored such that the resonant frequency of the dynamic absorber in torsion 13 corresponds to the frequency of the vibrations to be filtered out. The resonant frequency of the dynamic absorber in torsion 13 is, for example, comprised between 1 and 20 Hz, more particularly between 4 and 10 Hz, for example of the order of 6 to 8 Hz, which more particularly corresponds to a resonant frequency of the drivetrain 1.

The inertial mass 15 has, for example, a moment of inertia comprised between 0.001 and 0.010 kg.m², and more specifically between 0.005 and 0.006 kg.m². Such an dynamic absorber in torsion 13 is thus particularly well suited to being associated with a rotor having a moment of inertia substantially 10 times higher, namely comprised between 0.010 and 0.100 kg.m².

Moreover, the single elastic member that models the collection of elastic members 16 of the dynamic absorber in torsion 13 has, for example, an angular stiffness comprised between 0.01 and 0.70 Nm/°.

In the embodiment of FIG. 1, the dynamic absorber in torsion 13 is mounted on the coupling device 6 that couples the rotor shaft 4 and the primary shaft 5 of the reduction mechanism 3. Thus, by way of example, when the coupling device 6 is a sleeve, the support element 14 of the dynamic absorber in torsion 13 is mounted on said sleeve. When the coupling device 6 is a clutch device, the support element 14 of the dynamic absorber in torsion 13 may notably be mounted on the mechanism of the clutch device or on a friction disk of said clutch.

FIGS. 2, 3 and 4 depict drivetrains according to other embodiments. These embodiments differ from the embodiment described hereinabove in terms of the position of the dynamic absorber in torsion 13. Note that, in all the embodiments illustrated, the dynamic absorber in torsion 13 is associated either directly with the rotor shaft 4 or with an element of the drivetrain that is connected to said rotor shaft 4 without a reduction ratio.

In the embodiment of FIG. 2, the support element 14 of the dynamic absorber in torsion 13 is mounted on the rotor shaft 4. In FIG. 2, the dynamic absorber in torsion 13 is fixed to the rotor shaft 4 at one end of said shaft 4, which is the opposite end to the end coupled to the primary shaft 5 of the reduction mechanism 3.

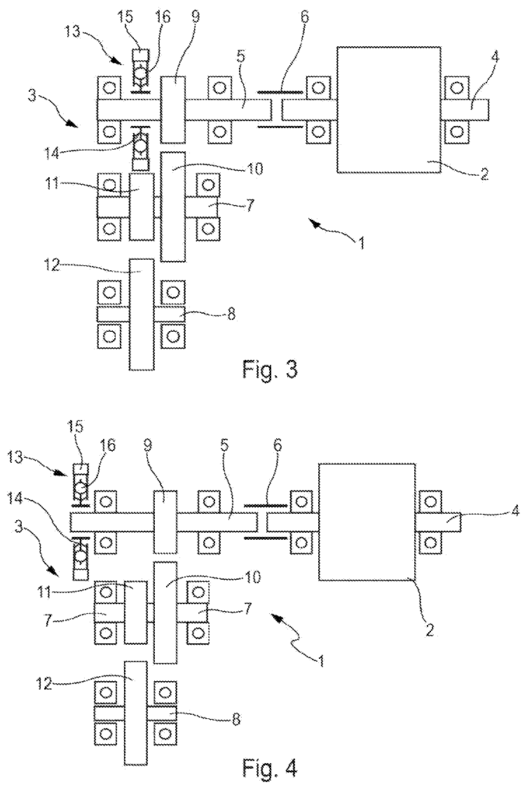

In the embodiments of FIGS. 2 and 3, the support element 14 of the dynamic absorber in torsion 13 is mounted on the primary shaft 5. In the embodiment of FIG. 3, the support element 14 of the dynamic absorber in torsion 13 is positioned between the two bearings that support the primary shaft 5, whereas, in the embodiment of FIG. 4, the support element 14 of the dynamic absorber in torsion 13 is positioned at one end of the primary shaft 5, which is the opposite end to the end coupled to the rotor shaft 4.

According to embodiment variants, the dynamic absorber in torsion 13 comprises a hysteresis device, not depicted. A hysteresis device is configured to apply a frictional resistive torque when there is relative rotation between the inertial mass 15 and the support element 14, so that some of the energy accumulated in the elastic members 16 can be dissipated by friction.

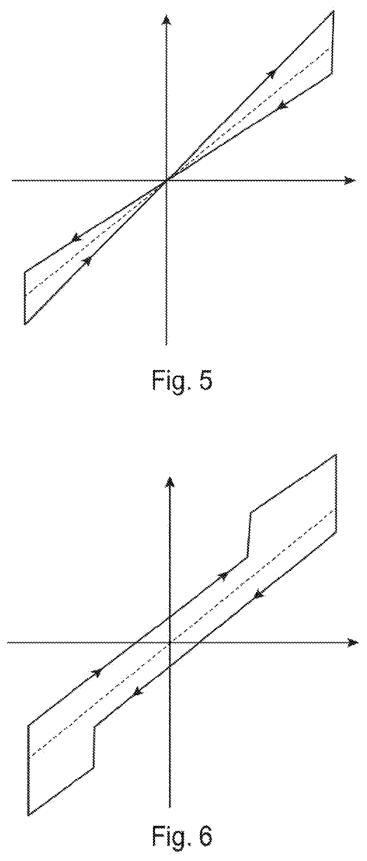

FIG. 5 shows a curve illustrating the torque that passes through the dynamic absorber in torsion 13 as a function of the angular travel of the inertial mass 15 with respect to the support element 14. In the embodiment of FIG. 5, the hysteresis device applies a frictional torque which varies according to the angular travel and, more particularly, which increases as the travel of the inertial mass with respect to its rest position increases. In this embodiment variant, the curve illustrating the frictional torque as a function of angular travel is a linear function. In other words, the frictional torque changes in proportion to the angular travel. By way of example, the structure of a hysteresis device able to obtain such a frictional torque is described in application WO11060752.

FIG. 6 shows a curve illustrating the torque that passes through the dynamic absorber in torsion as a function of the angular travel of the inertial mass with respect to the support element according to another embodiment. The hysteresis device likewise applies a frictional torque which varies according to the angular travel and more particularly which increases. However, in this embodiment, the frictional torque increases in steps. To achieve this, the hysteresis device comprises first hysteresis means which apply a frictional torque that remains constant whatever the angular travel, and second hysteresis means with conditional activation which apply a frictional torque only in certain relative positions. In particular, the second hysteresis means with conditional activation apply a frictional torque only in one direction, which is to say when the travel increases and upward of a threshold angular value.

Although the invention has been described in connection with a plurality of particular embodiments, it is quite obvious that it is in no way limited thereto and that it comprises all the technical equivalents of the means described and combinations thereof where these fall within the scope of the invention.

The use of the verb “have”, “comprise” or “include” and conjugated forms thereof does not exclude the presence of elements or steps other than those stated in a claim.

In the claims, any reference sign between parentheses should not be interpreted as limiting the claim.

1. A drivetrain for motor vehicle comprising an electric motor and a reduction mechanism designed to transmit the driving torque to the wheels of the motor vehicle; the electric motor comprising a rotor equipped with a rotor shaft, said rotor shaft being rotationally coupled to a primary shaft of the reduction mechanism, the drivetrain further comprising a dynamic absorber in torsion, said dynamic absorber in torsion comprising a support element, an inertial mass which is mounted with the ability to rotate about an axis X with respect to the support element and elastic members which oppose the relative rotation of the inertial mass with respect to the support element about said axis X.

2. The drivetrain as claimed in claim 1, wherein the resonant frequency of the dynamic absorber in torsion is comprised between 1 and 20 Hz.

3. The drivetrain as claimed in claim 2, wherein the resonant frequency of the dynamic absorber in torsion is comprised between 4 and 10 Hz.

4. The drivetrain as claimed in claim 1, wherein the inertial mass has a moment of inertia comprised between 0.001 and 0.010 kg.m².

5. The drivetrain as claimed in claim 1, wherein the inertial mass has a moment of inertia comprised between 0.005 and 0.006 kg.m².

6. The drivetrain as claimed in claim 1, wherein the motor shaft is rotationally coupled to the primary shaft of the reduction mechanism by means of a coupling device, the support element of the dynamic absorber in torsion being mounted on said coupling device.

7. The drivetrain as claimed in claim 1, wherein the support element of the dynamic absorber in torsion is mounted on the rotor shaft.

8. The drivetrain as claimed in claim 1, wherein the support element of the dynamic absorber in torsion is mounted on the primary shaft.

9. The drivetrain as claimed in claim 1, wherein the dynamic absorber in torsion comprises a hysteresis device.

10. A motor vehicle equipped with a drivetrain as claimed in claim 1.

11. The drivetrain as claimed in claim 2, wherein the inertial mass has a moment of inertia comprised between 0.001 and 0.010 kg.m².

12. The drivetrain as claimed in claim 2, wherein the inertial mass has a moment of inertia comprised between 0.005 and 0.006 kg.m².

13. The drivetrain as claimed in claim 2, wherein the motor shaft is rotationally coupled to the primary shaft of the reduction mechanism by means of a coupling device, the support element of the dynamic absorber in torsion being mounted on said coupling device.

14. The drivetrain as claimed in claim 2, wherein the support element of the dynamic absorber in torsion is mounted on the rotor shaft.

15. The drivetrain as claimed in claim 2, wherein the support element of the dynamic absorber in torsion is mounted on the primary shaft.

16. The drivetrain as claimed in claim 2, wherein the dynamic absorber in torsion comprises a hysteresis device.

17. A motor vehicle equipped with a drivetrain as claimed in claim 2.

18. The drivetrain as claimed in claim 3, wherein the inertial mass has a moment of inertia comprised between 0.001 and 0.010 kg.m².

19. The drivetrain as claimed in claim 3, wherein the inertial mass has a moment of inertia comprised between 0.005 and 0.006 kg.m².

20. The drivetrain as claimed in claim 3, wherein the motor shaft is rotationally coupled to the primary shaft of the reduction mechanism by means of a coupling device, the support element of the dynamic absorber in torsion being mounted on said coupling device.
